(19) United States
(12) Patent Application Publication
(10) Pub. No.: US 2013/0147786 A1
(43) Pub. Date: Jun. 13, 2013

(54) METHOD AND APPARATUS FOR EXECUTING HIGH PERFORMANCE COMPUTATION TO SOLVE PARTIAL DIFFERENTIAL EQUATIONS AND FOR OUTPUTTING THREE-DIMENSIONAL INTERACTIVE IMAGES IN COLLABORATION WITH GRAPHIC PROCESSING UNIT, COMPUTER READABLE RECORDING MEDIUM, AND COMPUTER PROGRAM PRODUCT

(71) Applicants: Mattew Ross SMITH, Tainan City (TW); Heng-Chuan KAN, Tainan City (TW)

(72) Inventors: Mattew Ross SMITH, Tainan City (TW); Heng-Chuan KAN, Tainan City (TW)

(21) Appl. No.: 13/314,832

(22) Filed: Dec. 8, 2011

(51) Int. Cl. G06T 15/00

(52) U.S. Cl. 345/419

(57) ABSTRACT

A method and apparatus for executing high performance computation to solve PDEs and for outputting three-dimensional interactive images in collaboration with a GPU is disclosed. The method includes: (A) executing a coordinate transformation to a three-dimensional image by the CPU, setting a boundary condition required by a simulation according to a coordinate transformation result, and inputting the boundary condition to the GPU; (B) executing a numerical simulation of the PDEs and the boundary condition in the step (A); (C) processing and rendering each drawn element by the GPU according to a numerical simulation result to draw a visual image featured with physical quantity variation and overlapping the visual image on the three-dimensional image to form the three-dimensional interactive images.

### BACKGROUND OF THE INVENTION

1. Field of the Invention

The present invention relates to a method and apparatus for executing a high performance computation to solve partial differential equations (PDEs) and for outputting three-dimensional interactive images in collaboration with a graphic processing unit (GPU), a computer readable recording medium and a computer program product, and in particular relates to that the GPU is fully utilized to execute the PDE computation, three-dimensional interactive images provided with physical quantity variation is fully drawn by the GPU according to the computed result, and an output device.

2. Description of the Related Art

With the rapid developments and changes of scientific technologies, high performance computation has been widely applied to the researches concerning people's livelihoods, such as medical diagnosis, three-dimensional interactive teaching, global climate change, and energy transferring and destroying effect simulations of natural disasters (e.g., tsunami, earthquake and typhoon). Therefore, a large-scale rendering is gradually considered in the simulation process. Taking a graphic processing unit (GPU) for example, the GPU is featured with low cost and low-energy consumption, capable of being an alternative high performance computation component to replace the CPU.

With respect to the establishment of simulation boundary conditions, an augmented reality image is related to a novel method, capable of rapidly inputting images and establishing many models for use in the simulation process, such as architectures, human organs or natural environments.

However, in the high performance computation method of using the GPU to solve the PDEs, it is conventionally to command the GPU to execute a fraction of job, as shown in FIG. 5. In FIG. 5, in the collaborative computation of the CPU and the GPU, a dotted block represents a command executed by the GPU under the requests of the CPU, a real-line block represents executing positions of the amount of rendering work, a single real-line arrow represents a data transmission between the CPU and the GPU, and a double real line arrow represents the progress of whole computing simulation administrated and controlled by the CPU. In FIG. 5, it can be seen that both the CPU and the GPU are related to the data transmission in the computing process, but image input lags are often occurred in the massive data transmission process. Furthermore, the GPU is often in a non-operational state in the whole computing process, such that the efficiency of the GPU cannot be fully developed.

Moreover, if the CPU is only to be used for driving the augmented reality technique to display the high-performance computing simulation result, the three-dimensional interactive images still cannot be output in real time.

Referring also to FIG. 6, in the conventional computation of flux F for a standard Finite Volume Method (FVM), a single thread on the GPU device must have access to the conditions in neighboring cells. The performance of the computation is heavily affected due to the heavy access to global memory on the GPU required for the flux computation, which results in substantial lag and the inability to perform computation in real time.

### BRIEF SUMMARY OF THE INVENTION

To fully exploit the graphic processing unit (GPU) for high performance computation and overcome the image input and computational lags, the present invention implements the computation of partial differential equations (PDEs) entirely on the GPU using a split flux algorithm, after which the GPU performs the drawing processing computations and completes the output process according to the result of the simulated computation of the PDEs, thereby outputting images in real time to solve the image input lags.

The present invention further provides a technique, capable of inputting a three-dimensional image by utilizing an augmented reality, utilizing a central processing unit (CPU) to execute the establishment of an augmented reality three-dimensional image, setting coordinate and boundary condition according to the three-dimensional image, collaborating with the high performance computation of the GPU, and integrating the augmented reality three-dimensional image to real-time output the three-dimensional interactive images provided with physical quantity variation.

Therefore, the present invention is a method for executing a high performance computation to solve partial differential equations and for outputting three-dimensional interactive images in collaboration with a GPU, comprising the steps of:

(A) executing a coordinate transformation to a three-dimensional image by a CPU, setting a boundary condition required by a simulation according to a coordinate transformation result, and inputting the boundary condition to the GPU;

(B) executing a numerical simulation of partial differential equations by the GPU according to the boundary condition provided in the step (A); and

(C) processing and rendering each drawn element by the GPU according to a numerical simulation result to draw a visual image featured with physical quantity variation and overlapping the visual image on the three-dimensional image so as to form the three-dimensional interactive images output by a display unit.

Further, in the steps (B) and (C), a data transmission between the CPU and the GPU is only related to job commands transmitted from the CPU to the GPU, and a feedback command is transmitted from the GPU to the CPU when the tasks allocated to the GPU are completed.

Further, the numerical simulation in the step (B) is operated by a Finite Volume Method (FVM), comprising a split flux calculation of the FVM and a state calculation of the FVM.

Further, in the step (C) the GPU is controlled through the use of CUDA to accelerate the rendering and computational speed thereof.

Further, in the step (A), the three-dimensional image is an augmented reality (AR) image generated by a captured image of a marker taken by a camera unit, and the marker comprises a real object or a projected object.

Further, the CPU is utilized to execute a computer system process initialization setting job prior to the step (A), comprising the steps of: (A1) displaying a drawing application program to be initialized on the display unit; (A2) assigning a memory space required by a computer host by the CPU; (A3) duplicating the partial differential equations to be simulated to a memory space of the GPU; and (A4) using an augmented reality tool to activate the camera unit.

Further, the method further comprises a step (D) after the step (C), wherein the step (D) uses the CPU to execute a computer system process for job ending and comprises the steps of: (D1) releasing the memory space of the GPU; (D2) releasing the memory space of the computer host; (D3) terminating the operation of the camera unit; and (D4) terminating the operation of the display unit.

The present invention is also an apparatus for executing high performance computation to solve partial differential equations and for outputting three-dimensional interactive images in collaboration with a GPU, comprising a computer host and a display unit. The computer host comprises a CPU, the GPU and an application program installed in the computer host. The display unit is electrically connected to the computer host. The application program provides a method to enable the computer host for executing the high performance computation to solve the partial differential equations and for outputting the three-dimensional interactive images in collaboration with the GPU, and the display unit displays the three-dimensional interactive images of the computed result.

Further, the apparatus is one of a personal computer, a game console or an intelligent hand-held device containing a GPU.

The present invention is also a computer readable recording medium stored with an application program providing a method enabling a computer host for executing high performance computation to solve partial differential equations and for outputting three-dimensional interactive images in collaboration with a GPU.

The present invention is also a computer program product utilized to install an application program in a computer host, the application program providing a method enabling the computer host for executing high performance computation to solve partial differential equations and for outputting three-dimensional interactive images in collaboration with a GPU.

The present invention is provided with the effect as follows.

The GPU, utilized to execute the complicated computation provided with physical quantity variation, is capable of efficiently outputting the computed result in real-time, and the output result at least comprises the dynamic three-dimensional interactive images provided with real-time physical quantity variation and the smooth dynamic three-dimensional interactive images. Due to the powerful computing functions, the cost of simulating real-time three-dimensional interactive images can be reduced. The augmented reality image is not only a simple three-dimensional dynamic image, but it also comprises a real-time three-dimensional simulation result provided with the complicated physical quantity variation, based on the interactions of particular parameters between the included objects. In the simulation process, the computed result of transformation of any parameters or objects can be rapidly obtained with real time and immediately output. Further, the complicated computation can be output at high speed, and two hundred or more frames per second of the dynamic three-dimensional interactive images can be output with real time. With high efficiency outputting result, the present invention can observe any tiny changes of an object in the simulation process.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram showing a flow chart of a collaborative computation of a CPU and a graphic processing unit (GPU) of the present invention;

FIG. 2 is a schematic diagram showing that a single thread on the CPU device is utilized to calculate a split flux in the step (C) of an embodiment of the present invention;

FIG. 3 is a schematic diagram showing that in the step (C) a GPU is controlled through the use of CUDA to accelerate the rendering and computational speed thereof in the step (D) of an embodiment of the present invention;

FIG. 4 is a simplified flow chart of a collaborative computation of a CPU and a GPU, illustrating that the present invention has a high performance computation superior to the conventional method;

FIG. 5 is a schematic diagram showing a flow chart of a collaborative computation of a CPU and a GPU in the conventional method; and

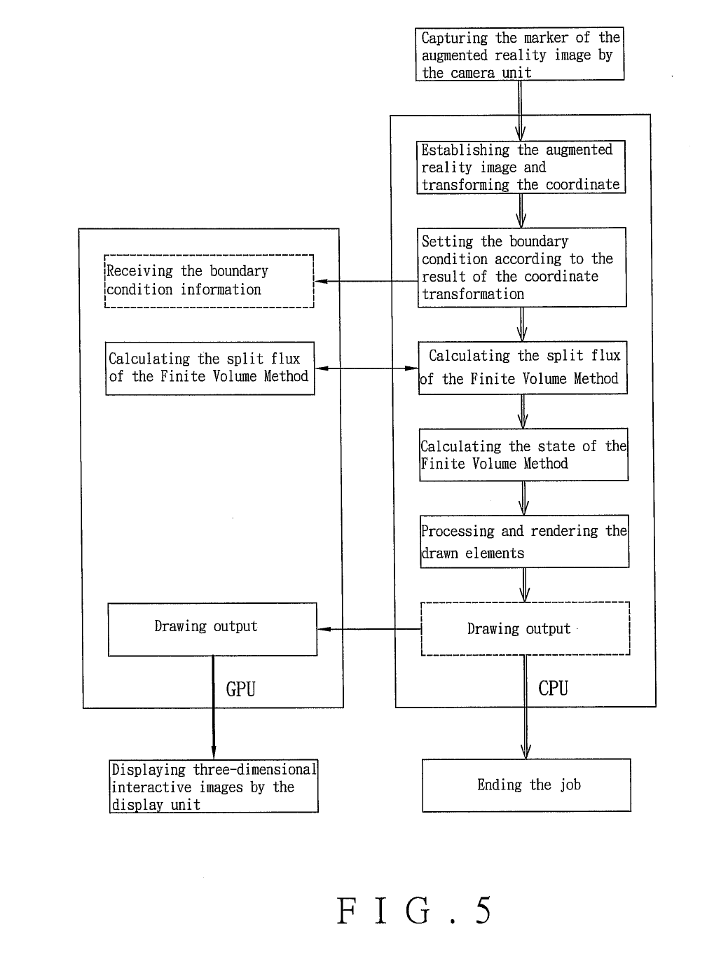

FIG. 6 is a schematic diagram showing that a GPU is utilized to calculate a split flux in the conventional method.

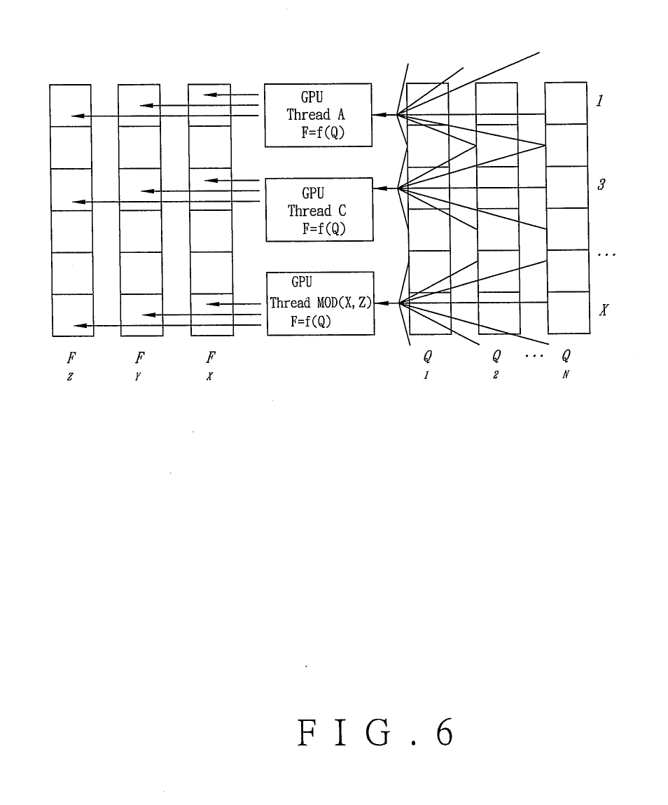

### DETAILED DESCRIPTION OF THE INVENTION

According to the above-described technical features of the present invention, the main effect of a method and an apparatus for executing a high performance computation to solve partial differential equations (PDEs) and for outputting three-dimensional interactive images in collaboration with a graphic processing unit (GPU), a computer readable recording medium and a computer program product can be more fully understood by reading the subsequent embodiment.

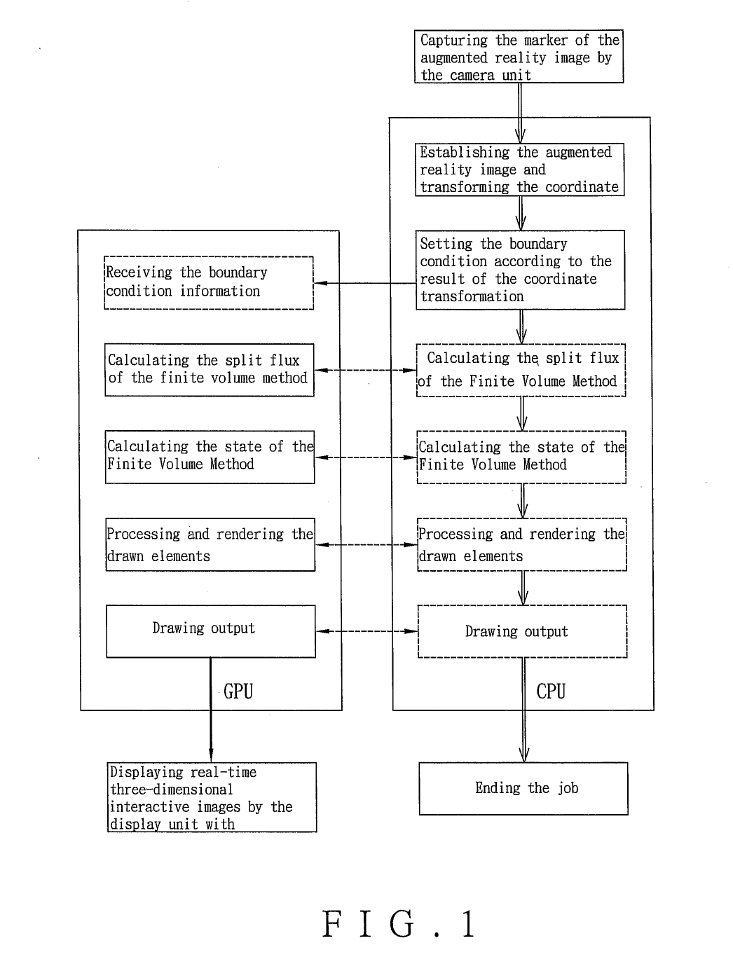

Referring to FIG. 1, in the disclosure of an embodiment of the present invention, a central processing unit (CPU) with a given simulation conditions is utilized to process an augmented reality (AR) image, the GPU is fully utilized to execute complicated calculations of the PDEs, such that a representative result of the PDEs provided with physical quantity variation can be rapidly calculated by the GPU of high performance computation. With the GPU, this result provided with physical quantity variation is drawn into a visual image overlapped on the augmented reality three-dimensional image, such that the real-time output augmented reality image can have the three-dimensional interactive images provided with physical quantity variation. In FIG. 1, in the collaborative computation of the CPU and the GPU, a dotted block represents a command executed by the GPU under the requests of the CPU, a real-line block represents executing positions of the amount of rendering work, a single real-line arrow represents a data transmission between the CPU and the GPU, a single dotted-line arrow represents a job command and a feedback command between the CPU and the GPU, a double real line represents the progress of whole computing simulation administrated and controlled by the CPU, and a bold real line represents the GPU drawing output by a display unit.

This embodiment comprises the steps of:

(A) Use the CPU to execute a computer system process initialization setting job. The computer system process initialization setting job comprises the steps of:
(A1) displaying a drawing application program (e.g., OpenGL, DirectDraw, or DirectX, etc.) to be initialized on the display unit;
(A2) assigning a memory space required by a computer host by the CPU;
(A3) duplicating the PDEs to be simulated to a memory space of the GPU; and
(A4) using an augmented reality tool to activate the camera unit.

(B) With an augmented reality technique, a captured image of a marker is taken by a camera unit, and an augmented reality three-dimensional image is generated by identifying the captured image, wherein the marker can be a real object marker or a projected object marker generated by a projector. Then, the CPU performs a coordinate transformation of the augmented reality three-dimensional image, simulates a boundary condition required by a simulation according to a coordinate transformation result, and input the boundary condition to the GPU.

(C) The GPU performs a numerical computation of the PDEs according to the PDEs provided by the step (A) and the boundary condition provided by the step (B). Taking a Finite Volume Method (FVM) for example, the operation of the FVM related to a split flux calculation of the FVM and a state calculation of the FVM. Referring to FIG. 1, the CPU transmits a job command of ‘split flux calculation of the FVM’ to the GPU and commands the GPU to execute the related computations, and a feedback command is transmitted from the GPU to the CPU when the tasks allocated to the GPU are completed. The CPU transmits the next job command of ‘the FVM’ to the GPU when the CPU receives the feedback command, and commands the GPU to execute the related computations and to repeat the previous computing pattern. The GPU transmits a feedback command to the CPU when the tasks allocated to the GPU are completed.

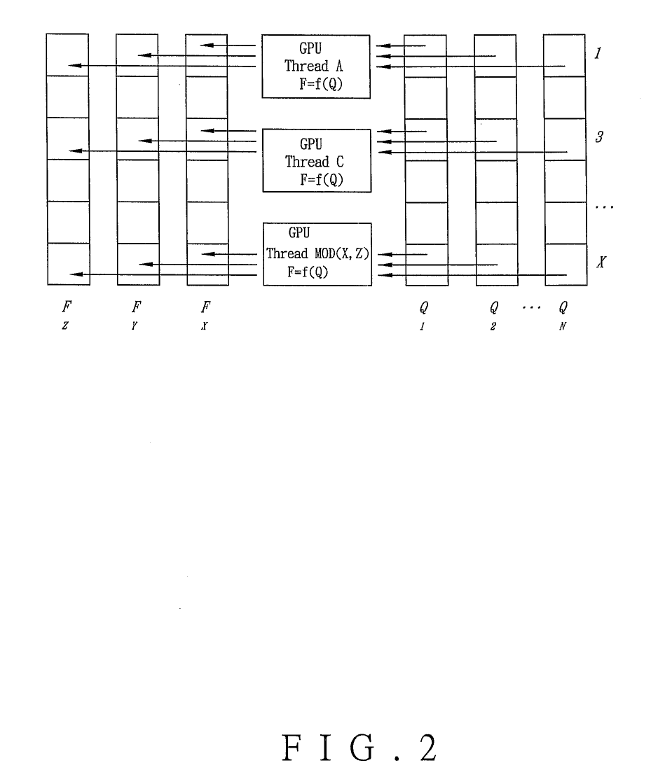

Referring to FIG. 2, for a thread of the GPU, the present invention can effectively use a single thread on the GPU device to calculate a split flux (F=f(Q)). That is, it is unnecessary to spend the computing cost associated with finding the neighboring cell conditions, such that excellent computing efficiency across the multiple theads of the GPU can be obtained.

(D) Referring to FIG. 1, when the CPU receives the feedback command transmitted from the GPU to confirm that the PDE computation is completed by the GPU, the CPU commands the GPU to execute a drawing job including to process and render each drawn element and to draw a visual image to be output to the display unit, etc. The CPU first transmits a job command of ‘to process and render each drawn element’ to the GPU, and the GPU processes and renders the drawn elements according to a numerical simulation result. Then, the GPU transmits a feedback command to the CPU when the tasks allocated to the GPU are completed, and the CPU transmits the next job command of ‘drawing output’ to the GPU when the CPU receives the feedback command transmitted from the GPU. Thus, the GPU can draw a visual image featured with physical quantity variation and overlap the visual image on the three-dimensional image so as to form the three-dimensional interactive images output by the display unit.

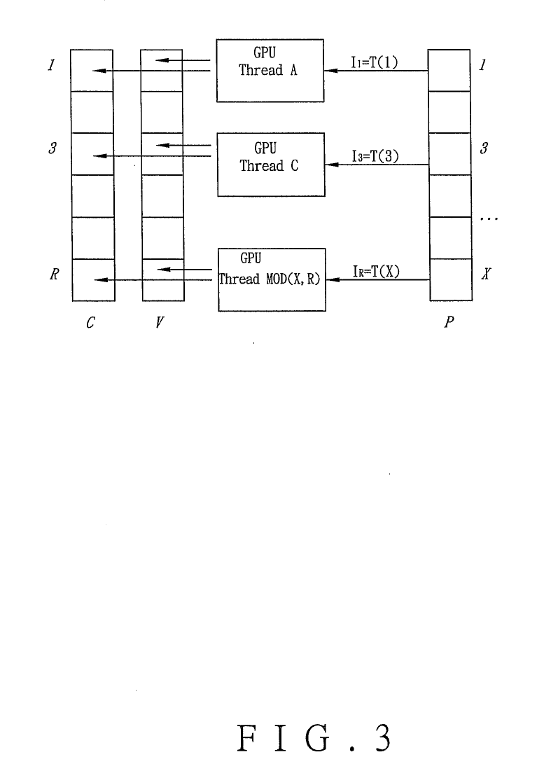

Referring to FIG. 3, in the computing process of the step (D), the GPU is controlled through the use of CUDA to accelerate the rendering and computational thereof, primarily to use a CUDA core syntax to process the data (P) from a memory space and secondarily to execute an index conversion ((I_{R}=T(X))). Then, the CUDA core syntax redefines the color ‘C’ and the apex ‘V’ and stores the data in the physical memory space prior to rendering process.

In the steps (C) and (D), a data transmission between the CPU and the GPU is only related to a job command transmitted from the CPU to the GPU, a feedback command is transmitted from the GPU to the CPU when the tasks allocated to the GPU are completed, the GPU is fully utilized to execute the complicated calculations related to the physical quantity, and the GPU is fully utilized to execute the drawing output. Therefore, with the high performance computation of the GPU itself, the dynamic three-dimensional interactive images provided with physical quantity variation and smooth pictures can be immediately output by the GPU. Further, the steps (C) and (D) can be repeatedly executed to immediately output different simulation results according to the required simulation jobs.

(E) When the simulation jobs are completed, the CPU is utilized to finally execute a computer system process for job ending, comprising the steps of:
(E1) releasing the memory space of the GPU;
(E2) releasing the memory space of the computer host;
(E3) terminating the operation of the camera unit; and
(E4) terminating the operation of the display unit.

The above-described processes are utilized to execute the computer system for job ending.

Thereinafter a scientific calculation theory is cited to explain that, in the instance of a collaborative computation of the CPU and the GPU, the optimal outcome is such that the GPU fully utilized to execute all complicated calculations of PDEs rather than splitting the workload between the CPU and the GPU, hence allowing the application to real time high performance computation (HPC) using GPU and augmented reality technologies.

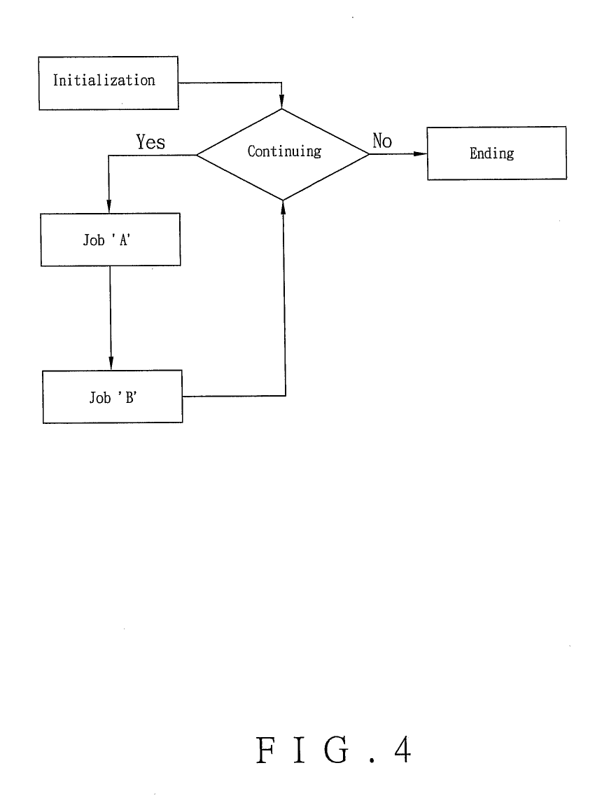

Referring to FIG. 4, the speed-up effect on the calculation of the present invention can be proved by Gustafson's Law and the following equation is set forth:

SU=a+P(1−a)

wherein ‘SU’ represents the speed-up ratio, ‘a’ represents that the fraction of work that cannot be parallelized in the rendering process, and ‘P’ represents the number of processors.

A required source consumption ‘F_{INIT}’ in the initialization process can be set by the following formula:

F_{INIT}=k_{INIT}N

wherein ‘N’ represents the number of cells, and ‘k_{INIT}’ represents the required source consumption of each cell in the initialization process.

Presume that in FIG. 4 a linear relationship is formed between the required source consumption in executing the jobs ‘A’ and ‘B’ and the number of cells ‘N’ and the following formulas are set forth:

F_{A}=k_{A}NF_{B}=k_{B}N

wherein ‘k_{A}’ and ‘k_{B}’ represent the required source consumption of each cell in the rendering process.

A required source consumption ‘F_{COM}’ in the communications between the CPU and the GPU can be set by the following formula:

F_{COM}=k_{COM}N

wherein k_{COM} represents the required source consumption of each cell in the communications between the CPU and the GPU.

The following formulas can be obtained according to Gustafson's Law.

(I) When the jobs ‘A’ and ‘B’ are parallelized by the CPU and the GPU in the rendering process, i.e., when a fraction of the PDE computation is executed by the CPU and a fraction of the drawing output is executed by the GPU, the formulas can be obtained as follows:

$$\begin{matrix}\begin{matrix}{a}_{CPU \text{-} GPU} = \frac{{k}_{INIT} N + 2 {k}_{COM} N ( 1 + S )}{{k}_{INIT} N + 2 {k}_{COM} N ( 1 + S ) + S ( {k}_{A} N + {k}_{B} N )} \\ = \frac{{k}_{INIT} + 2 {k}_{COM} ( 1 + S )}{{k}_{INIT} + 2 {k}_{COM} ( 1 + S ) + S ( {k}_{A} + {k}_{B} )} , and\end{matrix} & \\ {SU}_{CPU \text{-} GPU} = \frac{{k}_{INIT} + 2 {k}_{COM} + S ( {P}_{eff} {k}_{A} + {k}_{B} + 2 {k}_{COM} )}{{k}_{INIT} + 2 {k}_{COM} + S ( 2 {k}_{COM} + {k}_{A} + {k}_{B} )} & \end{matrix}$$

(II) When the jobs ‘A’ and ‘B’ are fully parallelized by the CPU and the GPU in the rendering process, i.e., when the PDE computation and the drawing output are fully executed by the GPU, the equations can be obtained as follows:

$$\begin{matrix}\begin{matrix}{a}_{GPU} = \frac{{k}_{INIT} N + 2 {k}_{COM} N}{{k}_{INIT} N + 2 {k}_{COM} N + S ( {k}_{A} N + {k}_{B} N )} \\ = \frac{{k}_{INIT} + 2 {k}_{COM}}{{k}_{INIT} + 2 {k}_{COM} + S ( {k}_{A} + {k}_{B} )} , and\end{matrix} & \\ {SU}_{GPU} = \frac{{k}_{INIT} + 2 {k}_{COM} + {P}_{eff} S ( {k}_{A} + {k}_{B} )}{{k}_{INIT} + 2 {k}_{COM} + S ( {k}_{A} + {k}_{B} )} & \end{matrix}$$

A further equation is defined and set forth as follows:

$${SU}_{R} = \frac{{SU}_{GPU}}{{SU}_{CPU / GPU}}$$

wherein ‘SU_{R}’ represents a specific value of the speed-up ratio when being fully parallelized by the GPU and the speed-up ratio when being fully parallelized by the CPU and the GPU.

It can be obtained the equation as follow:

$${SU}_{R} = \frac{\begin{matrix}( 2 ( 1 + S ) {k}_{COM} + {k}_{INIT} + S ( {k}_{A} + {k}_{B} ) ) \\ ( 2 {k}_{COM} + {k}_{INIT} + {P}_{eff} S ( {k}_{A} + {k}_{B} ) )\end{matrix}}{\begin{matrix}( 2 {k}_{COM} ( 1 + S ) + {P}_{eff} {Sk}_{A} + {k}_{INIT} + {Sk}_{B} ) \\ ( 2 {k}_{COM} + {k}_{INIT} + S ( {k}_{A} + {k}_{B} ) )\end{matrix}}$$

after simplification, this equation turns into

$${SU}_{R} = \frac{2 {k}_{COM}}{{k}_{A} + {k}_{B}} + 1$$

In the above-described equation, it can be found that the value of SU_{R} is greater than one, i.e., it ensures that the performance computing of the present invention is greater than that of the collaborative computation of the CPU and the GPU.

With the high performance computation of the GPU, the PDEs solution is fully executed by the GPU and the drawing output fully executed by the GPU of the present invention, three-dimensional image simulations related to dynamic energy transfers (e.g., energy transferring and destroying effect simulations of tsunami, earthquake and typhoon), three-dimensional image simulations related to vibrations (e.g., metallic fatigue or architecture shock resistance simulation under vibrations), three-dimensional image simulations related to fluid dynamics (e.g., air resistance simulation of vehicle carriers such as airplanes and automobiles), or simulations related to collision destructions (e.g., vehicle collision experiments and designs) can be output in real time.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for executing a high performance computation to solve partial differential equations and for outputting three-dimensional interactive images in collaboration with a graphic processing unit, comprising the steps of:
(A) executing a coordinate transformation to a three-dimensional image by a central processing unit, setting a boundary condition required by a simulation according to a coordinate transformation result, and inputting the boundary condition to the graphic processing unit;
(B) executing a numerical simulation of partial differential equations by the graphic processing unit according to the boundary condition provided in the step (A); and
(C) processing and rendering each of drawn elements by the graphic processing unit according to a numerical simulation result to draw a visual image featured with physical quantity variation and overlapping the visual image on the three-dimensional image so as to form the three-dimensional interactive images output by a display unit.

2. The method for executing the high performance computation to solve the partial differential equations and for outputting the three-dimensional interactive images in collaboration with the graphic processing unit as claimed in claim 1, wherein a data transmission between the central processing unit and the graphic processing unit in the steps (B) and (C) is only related to a job command transmitted from the central processing unit to the graphic processing unit, and a feedback command is transmitted from the graphic processing unit to the central processing unit when a task allocated to the graphic processing unit is completed.

3. The method for executing the high performance computation to solve the partial differential equations and for outputting the three-dimensional interactive images in collaboration with the graphic processing unit as claimed in claim 1, wherein the numerical simulation in the step (B) is operated by a Finite Volume Method, comprising a split flux calculation of the Finite Volume Method and a state calculation of the Finite Volume Method.

4. The method for executing the high performance computation to solve the partial differential equations and for outputting the three-dimensional interactive images in collaboration with the graphic processing unit as claimed in claim 1, wherein in the step (C) the graphic processing unit is controlled through CUDA to accelerate the rendering and computational speed thereof.

5. The method for executing the high performance computation to solve the partial differential equations and for outputting the three-dimensional interactive images in collaboration with the graphic processing unit as claimed in claim 1, wherein in the step (A) the three-dimensional image is an augmented reality image generated by a captured image of a marker taken by a camera unit.

6. The method for executing the high performance computation to solve the partial differential equations and for outputting the three-dimensional interactive images in collaboration with the graphic processing unit as claimed in claim 5, wherein the marker comprises a real object or a projected object.

7. The method for executing the high performance computation to solve the partial differential equations and for outputting the three-dimensional interactive images in collaboration with the graphic processing unit as claimed in claim 1, wherein the central processing unit is utilized to execute a computer system process initialization setting job prior to the step (A), comprising the steps of:
(A1) displaying a drawing application program to be initialized on the display unit;
(A2) assigning a memory space required by a computer host by the central processing unit;
(A3) duplicating the partial differential equations to be simulated to a memory space of the graphic processing unit; and
(A4) using an augmented reality tool to activate the camera unit.

8. The method for executing the high performance computation to solve the partial differential equations and for outputting the three-dimensional interactive images in collaboration with the graphic processing unit as claimed in claim 5 further comprising a step (D) after the step (C), wherein the step (D) uses the central processing unit to execute a computer system process for job ending and comprises the steps of:
(D1) releasing the memory space of the graphic processing unit;
(D2) releasing the memory space of the computer host;
(D3) terminating the operation of the camera unit; and
(D4) terminating the operation of the display unit.

9. An apparatus for executing high performance computation to solve partial differential equations and for outputting three-dimensional interactive images in collaboration with a graphic processing unit, comprising:
a computer host, comprising a central processing unit, the graphic processing unit and an application program installed in the computer host; and
a display unit electrically connected to the computer host;
wherein the application program provides a method to enable the computer host for executing the high performance computation to solve the partial differential equations and for outputting the three-dimensional interactive images in collaboration with the graphic processing unit, and the method comprises the steps of:
(A) executing a coordinate transformation to a three-dimensional image by the central processing unit, setting a boundary condition required by a simulation according to a coordinate transformation result, and inputting the boundary condition to the graphic processing unit;
(B) executing a numerical simulation of the partial differential equations by the graphic processing unit according to the boundary condition provided in the step (A); and
(C) processing and rendering each of drawn elements by the graphic processing unit according to a numerical simulation result to draw a visual image featured with physical quantity variation and overlapping the visual image on the three-dimensional image so as to form the three-dimensional interactive images output by the display unit.

10. The apparatus for executing the high performance computation to solve the partial differential equations and for outputting the three-dimensional interactive images in collaboration with the graphic processing unit as claimed in claim 9, wherein a data transmission between the central processing unit and the graphic processing unit in the steps (B) and (C) executed by the computer host is only related to a job command transmitted from the central processing unit to the graphic processing unit, and a feedback command is transmitted from the graphic processing unit to the central processing unit when a task allocated to the graphic processing unit is completed.

11. The apparatus for executing the high performance computation to solve the partial differential equations and for outputting the three-dimensional interactive images in collaboration with the graphic processing unit as claimed in claim 9, wherein the numerical simulation in the step (B) executed by the computer host is operated by a Finite Volume Method, comprising a split flux calculation of the Finite Volume Method and a state calculation of the Finite Volume Method.

12. The apparatus for executing the high performance computation to solve the partial differential equations and for outputting the three-dimensional interactive images in collaboration with the graphic processing unit as claimed in claim 9, wherein in the step (C) executed by the computer host the graphic processing unit is controlled through CUDA to accelerate the rendering and computational speed thereof.

13. The apparatus for executing the high performance computation to solve the partial differential equations and for outputting the three-dimensional interactive images in collaboration with the graphic processing unit as claimed in claim 9 further comprising a camera unit electrically connected to the computer host, wherein in the step (A) executed by the computer host the three-dimensional image is an augmented reality image generated by a captured image of a marker taken by the camera unit.

14. The apparatus for executing the high performance computation to solve the partial differential equations and for outputting the three-dimensional interactive images in collaboration with the graphic processing unit as claimed in claim 13, wherein the marker comprises a real object or a projected object.

15. The apparatus for executing the high performance computation to solve the partial differential equations and for outputting the three-dimensional interactive images in collaboration with the graphic processing unit as claimed in claim 13, wherein the central processing unit is utilized to execute a computer system process initialization setting job prior to the step (A) executed by the computer host, comprising the steps of:
(A1) displaying a drawing application program to be initialized on the display unit;
(A2) assigning a memory space required by a computer host by the central processing unit;
(A3) duplicating the partial differential equations to be simulated to a memory space of the graphic processing unit; and
(A4) using an augmented reality tool to activate the camera unit.

16. The apparatus for executing the high performance computation to solve the partial differential equations and for outputting the three-dimensional interactive images in collaboration with the graphic processing unit as claimed in claim 13 further comprising a step (D) after the step (C) executed by the computer host, wherein the step (D) uses the central processing unit to execute a computer system process for job ending and comprises the steps of:
(D1) releasing the memory space of the graphic processing unit;
(D2) releasing the memory space of the computer host;
(D3) terminating the operation of the camera unit; and
(D4) terminating the operation of the display unit.

17. The apparatus for executing the high performance computation to solve the partial differential equations and for outputting the three-dimensional interactive images in collaboration with the graphic processing unit as claimed in claim 9, wherein the apparatus is one of a personal computer, a game console or an intelligent hand-held device containing the graphic processing unit.

18. A computer readable recording medium stored with an application program providing a method enabling a computer host for executing high performance computation to solve partial differential equations and for outputting three-dimensional interactive images in collaboration with a graphic processing unit, the method comprising the steps of:
(A) executing a coordinate transformation to a three-dimensional image by a central processing unit, setting a boundary condition required by a simulation according to a coordinate transformation result, and inputting the boundary condition to the graphic processing unit;
(B) executing a numerical simulation of partial differential equations by the graphic processing unit according to the boundary condition provided in the step (A); and
(C) processing and rendering each of drawn elements by the graphic processing unit according to a numerical simulation result to draw a visual image featured with physical quantity variation and overlapping the visual image on the three-dimensional image so as to form the three-dimensional interactive images output by a display unit.

19. The computer readable recording medium as claimed in claim 18, wherein a data transmission between the central processing unit and the graphic processing unit in the steps (B) and (C) is only related to a job command transmitted from the central processing unit to the graphic processing unit, and a feedback command is transmitted from the graphic processing unit to the central processing unit when a task allocated to the graphic processing unit is completed.

20. The computer readable recording medium as claimed in claim 18, wherein the numerical simulation in the step (B) is operated by a Finite Volume Method, comprising a split flux calculation of the Finite Volume Method and a state calculation of the Finite Volume Method.

21. The computer readable recording medium as claimed in claim 18, wherein in the step (C) the graphic processing unit is controlled through CUDA to accelerate the rendering and computational speed thereof.

22. The computer readable recording medium as claimed in claim 18, wherein in the step (A) the three-dimensional image is an augmented reality image generated by a captured image of a marker taken by a camera unit.

23. The computer readable recording medium as claimed in claim 22, wherein the marker comprises a real object or a projected object.

24. The computer readable recording medium as claimed in claim 22, wherein the central processing unit is utilized to execute a computer system process initialization setting job prior to the step (A), comprising the steps of:
(A1) displaying a drawing application program to be initialized on the display unit;
(A2) assigning a memory space required by a computer host by the central processing unit;
(A3) duplicating the partial differential equations to be simulated to a memory space of the graphic processing unit; and
(A4) using an augmented reality tool to activate the camera unit.

25. The computer readable recording medium as claimed in claim 22 further comprising a step (D) after the step (C), wherein the step (D) uses the central processing unit to execute a computer system process for job ending and comprises the steps of:
(D1) releasing the memory space of the graphic processing unit;
(D2) releasing the memory space of the computer host;
(D3) terminating the operation of the camera unit; and
(D4) terminating the operation of the display unit.

26. A computer program product utilized to install an application program in a computer host, the application program providing a method enabling the computer host for executing high performance computation to solve partial differential equations and for outputting three-dimensional interactive images in collaboration with a graphic processing unit, the method comprising the steps of:
(A) executing a coordinate transformation to a three-dimensional image by a central processing unit, setting a boundary condition required by a simulation according to a coordinate transformation result, and inputting the boundary condition to the graphic processing unit;
(B) executing a numerical simulation of partial differential equations by the graphic processing unit according to the boundary condition provided in the step (A); and
(C) processing and rendering each of drawn elements by the graphic processing unit according to a numerical simulation result to draw a visual image featured with physical quantity variation and overlapping the visual image on the three-dimensional image so as to form the three-dimensional interactive images output by a display unit.

27. The computer program product as claimed in claim 26, wherein a data transmission between the central processing unit and the graphic processing unit in the steps (B) and (C) is only related to a job command transmitted from the central processing unit to the graphic processing unit, and a feedback command is transmitted from the graphic processing unit to the central processing unit when a task allocated to the graphic processing unit is completed.

28. The computer program product as claimed in claim 26, wherein the numerical simulation in the step (B) is operated by a Finite Volume Method, comprising a split flux calculation of the Finite Volume Method and a state calculation of the Finite Volume Method.

29. The computer program product as claimed in claim 26, wherein in the step (C) the graphic processing unit is controlled through CUDA to accelerate the rendering and computational speed thereof.

30. The computer program product as claimed in claim 26, wherein in the step (A) the three-dimensional image is an augmented reality image generated by a captured image of a marker taken by a camera unit.

31. The computer program product as claimed in claim 30, wherein the marker comprises a real object or a projected object.

32. The computer program product as claimed in claim 30, wherein the central processing unit is utilized to execute a computer system process initialization setting job prior to the step (A), comprising the steps of:
(A1) displaying a drawing application program to be initialized on the display unit;
(A2) assigning a memory space required by a computer host by the central processing unit;
(A3) duplicating the partial differential equations to be simulated to a memory space of the graphic processing unit; and
(A4) using an augmented reality tool to activate the camera unit.

33. The computer program product as claimed in claim 30 further comprising a step (D) after the step (C), wherein the step (D) uses the central processing unit to execute a computer system process for job ending and comprises the steps of:
(D1) releasing the memory space of the graphic processing unit;
(D2) releasing the memory space of the computer host;
(D3) terminating the operation of the camera unit; and
(D4) terminating the operation of the display unit.
